(19) United States
(12) Patent Application Publication
(10) Pub. No.: US 2014/0359012 A1
(43) Pub. Date: Dec. 4, 2014

(54) NON-TRANSITORY COMPUTER READABLE MEDIUM, INFORMATION SHARING SUPPORT SYSTEM, AND INFORMATION SHARING SUPPORT METHOD

(71) Applicant: FUJI XEROX CO., LTD., Tokyo (JP)

(72) Inventor: Takehito WATANABE, Kanagawa (JP)

(73) Assignee: FUJI XEROX CO., LTD., Tokyo (JP)

(21) Appl. No.: 14/139,328

(22) Filed: Dec. 23, 2013

(30) Foreign Application Priority Data
Jun. 4, 2013 (JP) 2013-118105

(51) Int. Cl. H04L 29/06

(52) U.S. Cl. CPC H04L 65/403
USPC 709/204

(57) ABSTRACT

A non-transitory computer readable medium stores a program causing a computer to execute a process including managing information about a user group performing information sharing with a virtual information sharing tool for every information sharing tool; acquiring information about a group of users who are adjacent to each other; determining the information sharing tool corresponding to the group of users who are adjacent to each other on the basis of a relevance of each information sharing tool to the group of users who are adjacent to each other, which is calculated in accordance with a similarity between the user group corresponding to the information sharing tool and the group of users who are adjacent to each other; and presenting the information sharing tool determined to have high relevance, among the information sharing tools, as a candidate corresponding to the group of users who are adjacent to each other.

### CROSS-REFERENCE TO RELATED APPLICATIONS

This application is based on and claims priority under 35 USC 119 from Japanese Patent Application No. 2013-118105 filed Jun. 4, 2013.

### BACKGROUND

### Technical Field

The present invention relates to a non-transitory computer readable medium, an information sharing support system, and an information sharing support method.

### SUMMARY

According to an aspect of the invention, there is provided a non-transitory computer readable medium storing a program causing a computer to execute a process including managing information about a user group which performs information sharing with a virtual information sharing tool for every information sharing tool; acquiring information about a group of users who are adjacent to each other; determining the information sharing tool corresponding to the group of users who are adjacent to each other on the basis of a relevance of each information sharing tool to the group of users who are adjacent to each other, which is calculated in accordance with a similarity between the user group corresponding to the information sharing tool, which is managed, and the group of users who are adjacent to each other indicated by the acquired information; and presenting the information sharing tool determined to have high relevance, among the information sharing tools, as a candidate corresponding to the group of users who are adjacent to each other.

### BRIEF DESCRIPTION OF THE DRAWINGS

Exemplary embodiments of the present invention will be described in detail based on the following figures, wherein:

FIG. 1 is a block diagram illustrating a functional configuration of an information sharing support system according to an exemplary embodiment;

FIG. 2 illustrates an example of management information managed by a virtual community management unit;

FIG. 3 illustrates an example of user management information managed by a user information management unit;

FIG. 4 illustrates an example of content management information managed by a content management unit;

FIG. 5 is a flowchart illustrating an exemplary process according to the exemplary embodiment;

FIG. 6 is a block diagram illustrating a functional configuration of an information sharing support system according to a modification;

FIG. 7 illustrates an example of management information managed by a meeting information management unit; and

FIG. 8 is a flowchart illustrating an exemplary process according to the modification.

### DETAILED DESCRIPTION

For example, companies each include departments that are organizationally fixed, such as divisions and sections, and user groups, such as temporary project teams, for specific purposes including new product development and promotion. Virtual information sharing tools, such as electronic bulletin boards, messaging services, and file sharing services (these are only examples), are increasingly used for information sharing in the user groups. In addition, information sharing services also exist in which multiple services including the electronic bulletin boards and the file sharing services are integrated. The virtual information sharing tools are built as, for example, one server or multiple servers cooperating with each other, which are provided on a data communication network, such as the Internet or an intranet.

In the information sharing in each user group, the virtual information sharing tool is prepared for every user group. Each user belonging to the user group accesses the information sharing tool corresponding to the user group to perform the information sharing with other users in the same user group by using the information sharing tool. A group of users associated with each other via the information sharing tool or the information sharing tool itself is hereinafter referred to as a “virtual community.” The users who perform the information sharing via the information sharing tool are considered to form the virtual community.

Specific scenes of the information sharing in the virtual community will now be described. Each member in a development project of a new product “A” logs into a portable Web page prepared for the project to have arguments with other members with the electronic bulletin board or the messaging system on the corresponding site. Alternatively, the member uploads materials for a meeting at a physical site on the file sharing service on the site; browses meeting material, which is downloaded, during the meeting; writes data on the meeting material during the meeting and uploads the result of the writing during the meeting to share the data with other participants of the meeting; and/or uploads the minutes of the meeting after the meeting to share the minutes with other members.

One user often belongs to multiple different user groups and may belong to quite a lot of user groups. The virtual communities of the number of the user groups to which a user belongs may possibly be used by the user. In the case of the information sharing services used in organizations of certain large sizes, such as companies, or public information sharing services, a huge number of virtual communities are managed by the services. It is necessary for the user to search for and select a virtual community which the user wants to access from the multiple virtual communities to which the user belongs or the huge number of virtual communities managed by the information sharing service used in the company or the like. Such search and selection operations place a burden on the user. In particular, a heavy burden is placed on the user who uses a mobile terminal, such as a smartphone or a tablet terminal, because, for example, the screen of the mobile terminal is small.

A typical example will be described below in which multiple users who carry the mobile terminals, such as the smartphones or the tablet terminals, are gathered together in the same place to hold a meeting or have a talk. A system will be described which assists the users so that the users are capable of easily using an appropriate virtual community corresponding to the meeting or the like. The system described below selects some candidates for the virtual community corresponding to the user group and narrows down the candidates to one virtual community corresponding to the user group on the basis of information about the users who are gathered together in positions that are physically adjacent to each other.

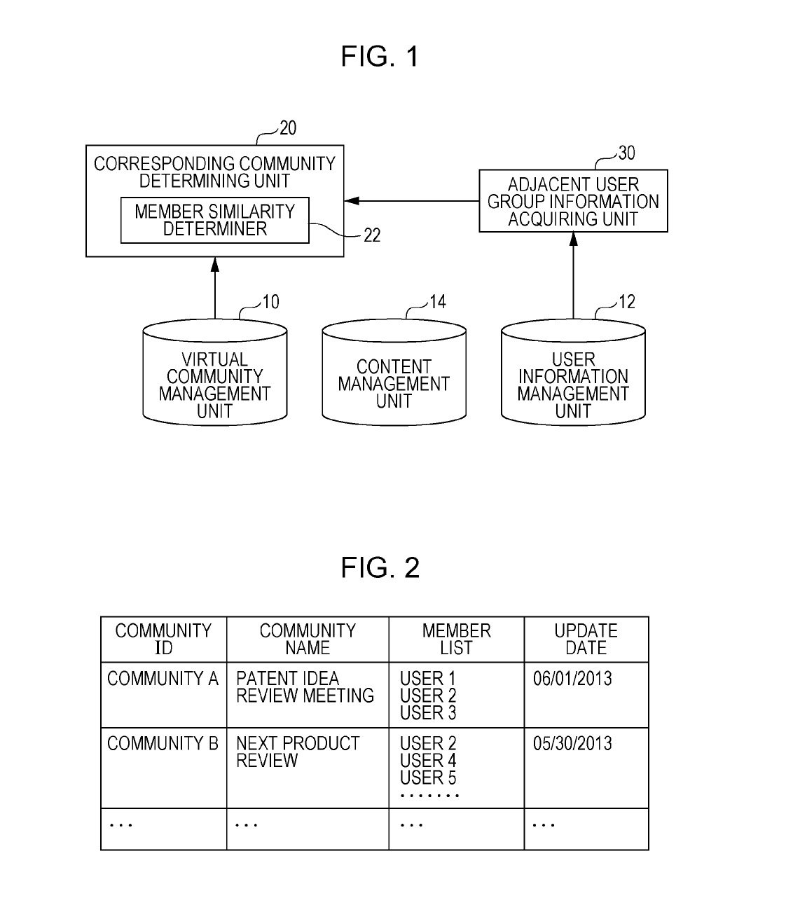

FIG. 1 is a block diagram illustrating a functional configuration of an information sharing support system according to an exemplary embodiment. This system composes, for example, a subsystem for the information sharing service in a company that manages multiple virtual communities. Elements concerning the information sharing support system (that is, a subsystem that narrows down the candidates to a virtual community (the information sharing tool) which probably corresponds to the group of users who are gathered in the same place or identifies the virtual community), among the subsystems for the information sharing service, are illustrated in FIG. 1.

Referring to FIG. 1, a virtual community management unit 10 stores and manages management information about each virtual community. FIG. 2 illustrates an example of the management information stored in the virtual community management unit 10.

In the example in FIG. 2, the virtual community management unit 10 stores information items including a community identifier (ID), a community name, a member list, and an update date for every virtual community. The community ID is identification information that uniquely identifies the virtual community. The community name is a name which the members of the virtual community give to the community.

The member list is a list of the user IDs of the members participating in the virtual community. The user ID is identification information that uniquely identifies each user in the information sharing service (or an organization, such as a company, which receives the information sharing service). A collection of the user IDs listed in the member list field represents the user group corresponding to the virtual community. The information in the member list is registered by, for example, a manager who manages the virtual community. Alternatively, a group of users who are adjacent to each other (that is, users who participate in a gathering at a physical site) acquired by an adjacent user group information acquiring unit 30 described below may be registered as the member list of the virtual community. The information registered in the member list field may be updated with information about the group of users who are adjacent to each other acquired by the adjacent user group information acquiring unit 30 each time a gathering, such as a meeting, is taken place. For example, a new user who meets an addition condition, such as a user who newly participates in a gathering at a physical site corresponding to the virtual community, (a user who is not a member of the virtual community at this time) may be added to the member list field or a member who meets a deletion condition, such as a member who stops to participate in the gathering, may be deleted from the member list field. Such addition and deletion may be automatically performed by the virtual community management unit 10 or may be performed in response to an acceptance of a member (for example, the manager) of the virtual community. In the latter case, the virtual community management unit 10 identifies a user who meets the addition or deletion condition to present the user to the manager or the like and, in response to the acceptance of the addition or deletion from the manger or the like, adds the user to the member list field or deletes the user from the member list field.

The information sharing service refers to the information in the member list to determine whether an access to the virtual community from the user (for example, login to an information sharing Web site corresponding to the virtual community) is accepted.

The update date indicates a latest update date when the information shared in the virtual community is updated. The shared information (the electronic bulletin board, a file to be shared, etc.) is stored in a content management unit 14. For example, examples of the update of the shared information include a case in which a new item is written in the electronic bulletin board, a case in which a new file is registered in the file sharing service, and a case in which an existing file is updated by editing or the like.

The information items illustrated in FIG. 2 are only examples. It is not necessary for the virtual community management unit 10 to store all the information items illustrated in FIG. 2 and may store information items other than the ones illustrated in FIG. 2.

Referring back to FIG. 1, a user information management unit 12 stores and manages management information about each user. The user information management unit 12 may be specific to the information sharing service or may be a database for user management, which is shared between various information processing services in an organization, such as a company.

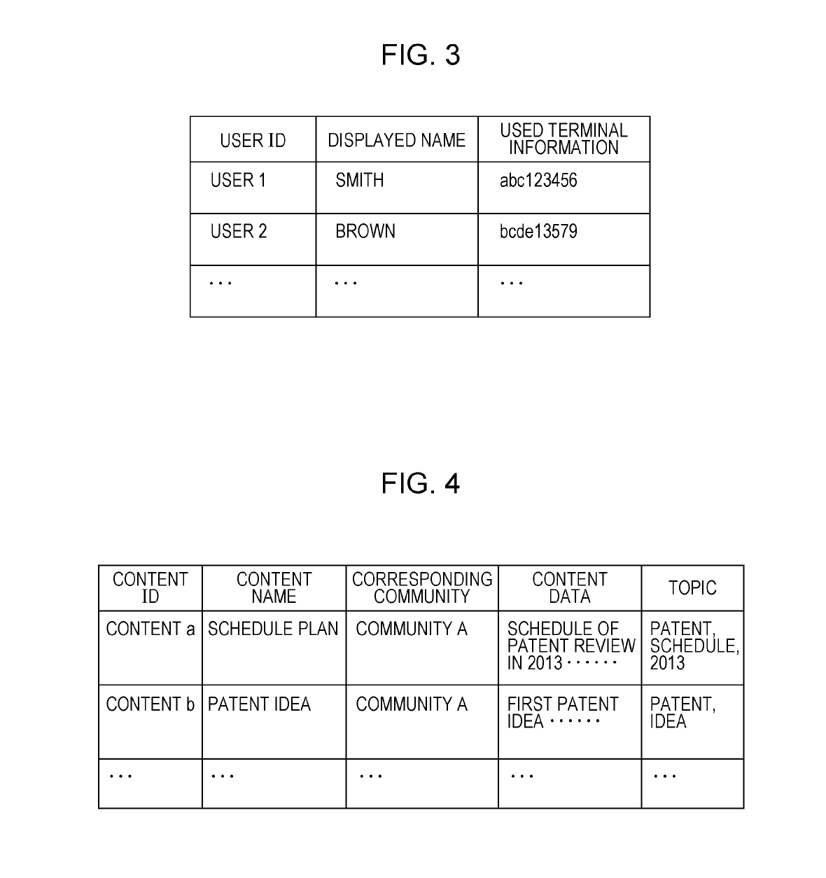

FIG. 3 illustrates an example of the user management information held in the user information management unit 12. In the example in FIG. 3, the user information management unit 12 stores information items including a user ID, a displayed name, and used terminal information for every user. The user ID is identification information about the user, as described above. The displayed name is a name used when the user is displayed in the information sharing service. For example, when an item posted by the user is displayed in the electronic bulletin board, the displayed name is displayed as information about the poster of the item. The used terminal information is identification information (for example, an individual identification number, such as a Media Access Control (MAC) address, or a mobile phone number) which uniquely identifies the mobile terminal used by the user. The used terminal information is used for the identification of the user when the user ID is not transmitted from the mobile terminal to the information sharing support system and the used terminal information is transmitted. The information items illustrated in FIG. 3 are only examples. It is not necessary for the user information management unit 12 to store all the information items illustrated in FIG. 3 and may store information items other than the ones illustrated in FIG. 3.

Referring back to FIG. 1, the content management unit 14 stores and manages data about pieces of content to be shared. The pieces of content to be shared include, for example, files including a document file, an image file, a movie file, an audio file, and a multimedia file, items in the electronic bulletin board, and messages in the messaging service.

FIG. 4 illustrates an example of content management information stored in the content management unit 14. The content management unit 14 stores information items including a content ID, a content name, a corresponding community, content data, and a topic for every piece of content. The content ID is identification information that uniquely identifies the content. The content name is a name which the user gives to the content and is exemplified by, for example, a file name. The corresponding community is identification information (community ID) about the virtual community in which the content is shared. The content data is the body data about the content (for example, a file). In the example in FIG. 4, a document file itself is registered in the “content data” field. Instead of the content itself, identification information about a location (for example, a file) where the content is stored may be registered in the “content data” field. The topic is topic information extracted from the body data about the content. The topic is extracted from the body data about the content by using a topic extraction technique or keyword extraction technique in related art or which will be developed. Alternatively, the user may input the topic of the content. Multiple topics may be registered for one piece of content.

The information items illustrated in FIG. 4 are only examples. It is not necessary for the content management unit 14 to store all the information items illustrated in FIG. 4 and may store information items other than the ones illustrated in FIG. 4.

Referring back to FIG. 1, the adjacent user group information acquiring unit 30 acquires information about a group of users participating a gathering at a physical site, that is, a group of users who are adjacent to each other. Various techniques have hitherto been proposed for identification of a group of users who are adjacent to each other. The adjacent user group information acquiring unit 30 identifies a group of users who are adjacent to each other by using an adjacent user group identification technique in the related art or which will be developed.

In an example, the adjacent user group information acquiring unit 30 identifies the user IDs of the respective users who are located in adjacent positions from the user ID (or the used terminal information) and positional information transmitted from the mobile terminal of each user to the system. The adjacent user group information acquiring unit 30 uses the user IDs that are identified as information representing the “group of users who are adjacent to each other.” The positional information is acquired by, for example, a Global Positioning System (GPS) sensor mounted in the mobile terminal. Specifically, in this example, upon instruction of access (for example, login) to the system by the user with an operation to, for example, invoke an application that is installed in the mobile terminal (that functions as a client for use of the information sharing service) to the mobile terminal, the mobile terminal (the application in the mobile terminal) transmits the user ID or the used terminal information which is stored and the positional information acquired from the GPS sensor to the system. The adjacent user group information acquiring unit 30 in the system identifies a group of users who are adjacent to each other, among the users, from the pieces of positional information transmitted from the mobile terminals of the respective users. The determination of whether the users are adjacent to each other may be based on a determination method in the related art, such as whether the distances between the users are shorter than a predetermined threshold value, or a determination method of the same purpose which will be developed. When the used terminal information is transmitted from the mobile terminal, the adjacent user group information acquiring unit 30 acquires the user ID corresponding to the used terminal information from the user information management unit 12.

In order to identify the “group of users who are adjacent to each other”, another method may be adopted in which the mobile terminals of users who are gathered together communicate with each other by a short-range communication method, such as infrared communication or short-range radio communication (for example, near field communication (NFC)), to recognize other mobile terminals adjacent to the own mobile terminals. In this method, upon access from a user, among the users who are gathered together, to the system, the mobile terminal of the user transmits the user ID (or the used terminal information) acquired from each mobile terminal which the mobile terminal has recognized by the short-range communication to the system. The adjacent user group information acquiring unit 30 in the system recognizes the group of the user IDs (or the pieces of used terminal information) received from the mobile terminal as the information about the “group of users who are adjacent to each other.”

A corresponding community determining unit 20 uses the information about the “group of users who are adjacent to each other” (hereinafter referred to as an “adjacent user group”) acquired by the adjacent user group information acquiring unit 30 to determine the virtual community corresponding to the user group.

In the example in FIG. 1, the corresponding community determining unit 20 uses a member similarity determiner 22 to acquire the similarity in the member list between the adjacent user group and each virtual community to determine the virtual community corresponding to the user group on the basis of the similarity.

For example, a correspondence rate of the members between a certain virtual community and the adjacent user group may be used as the similarity in the member list between the virtual community and the adjacent user group.

For example, the total number of members of the virtual community is used as a denominator in calculation of the correspondence rate. In this example, a value resulting from division of the number of the members belonging to the adjacent user group, among the members of the virtual community, by the total number of the members of the virtual community represents the similarity between the adjacent user group and the virtual community. For example, when the adjacent user group includes a user A, a user B, and a user C and the user A, the user B, and a user D participate in a virtual community, the two users: the user A and the user B, among the three members participating in the virtual community, correspond with the users of the adjacent user group. In this case, the similarity between the virtual community and the adjacent user group is ⅔≅66%. When the adjacent user group includes the user A, the user B, and the user C and the user A, the user D, and a user E participate in the virtual community, the similarity (the correspondence rate in this case) between the virtual community and the adjacent user group is 33%.

Alternatively, the total number of users included in the adjacent user group may be used as the denominator in the calculation of the similarity, that is, the correspondence rate. In this example, a value resulting from division of the number of users belonging to the virtual community, among the users in the adjacent user group, by the total number of users in the adjacent user group represents the similarity between the adjacent user group and the virtual community. For example, when the adjacent user group includes the user A, the user B, the user C, the user D, and the user E and the user A, the user B, and a user F participate in a virtual community, the two users: the user A and the user B, among the five users in the adjacent user group, correspond with the members of the virtual community. In this case, the similarity between the virtual community and the adjacent user group is ⅖=40%.

Alternatively, a value resulting from division of a double of the number of the users (the members) common to the adjacent user group and the virtual community by a sum of the total number of users in the adjacent user group and the total number of members of the virtual community may be used as the correspondence rate used as the similarity (the double of the number of the users (the members) common to the adjacent user group and the virtual community is used to balance with the sum of the total number of the users in the adjacent user group and the total number of members of the virtual community, which is used as the denominator).

Alternatively, the number of users (members) common to the adjacent user group and the virtual community may be directly used as the similarity.

Alternatively, instead of the correspondence rate or the number of the common users (members), a value resulting from substitution of the correspondence rate or the number of the common users (members) into a calculation expression may be used as the similarity.

If the number of users in the adjacent user group is considerably greater than the total number of members of the virtual community (for example, the result of subtraction of the total number of members of the virtual community from the number of users in the adjacent user group is greater than a predetermined threshold value), the virtual community may be excluded from the candidates without calculating the similarity in the member list. The exclusion is performed because many users who do not belong to the virtual community are included in the adjacent user group in this case and the probability of the correspondence of the adjacent user group to the virtual community is low.

In addition to the above exclusion, if the number of the users in the adjacent user group is considerably smaller than the total number of members of the virtual community, the virtual community may be excluded from the candidates without calculating the similarity in the member list.

Although all the members of the virtual community are treated with the same weight in the above examples, the members may be weighted in accordance with the level of participation to the virtual community (may be considered as the activity level). The higher weights are applied to the members having higher levels of participation in the calculation of the correspondence rate or the number of the common users (members).

For example, the participation rate to the gatherings corresponding to the virtual community may be used as the level of participation. Recording of the list of the participants of each past gathering and the virtual community corresponding to the gathering (which may be determined by using the system of the present exemplary embodiment) allows how many gatherings, among the total number of the past gatherings corresponding to the virtual community, each member of the virtual community participates to be calculated. The participation rate is calculated by dividing the number of times of participation by the total number of the past gatherings. The level of participation may be calculated in consideration of not only the participation to gatherings at physical sites corresponding to the virtual community but also the participation to the virtual community itself (specifically, registration of information, such as posting of an item to the electronic bulletin board or uploading of data, or browsing of information).

Instead of treating all the past participations with the same weight, higher weights may be applied to the participations to gatherings closer to the current time to calculate the participation rate. This causes the members who frequently participate in the virtual community in these days to greatly contribute to the similarity of the adjacent user group to the virtual community.

Upon calculation of the similarity of the virtual community to the adjacent user group by the member similarity determiner 22 in the above manner, the corresponding community determining unit 20 compares the similarity with a predetermined threshold value and, if the similarity is higher than the threshold value, the corresponding community determining unit 20 determines that the virtual community corresponds to (is similar to) the adjacent user group. For example, when the correspondence rate described above is used as the similarity and the threshold value is set 60%, the virtual community having a similarity of 60% is determined to correspond to the adjacent user group and the virtual community having a similarity of 30% is determined not to correspond to the adjacent user group.

The corresponding community determining unit 20 transmits the list of the virtual communities corresponding to the adjacent user group determined in the above manner to the mobile terminal of one or more users in the adjacent user group to cause the user to select the virtual community used in the current gathering from the list.

Upon selection of the virtual community by the user, the corresponding community determining unit 20 notifies the mobile terminal of each user included in the adjacent user group of the community ID of the virtual community that is selected. This allows the mobile terminal of each user to access the selected virtual community to browse the content registered in the virtual community and/or register information in the virtual community.

When one virtual community corresponds to the adjacent user group determined on the basis of the similarity, the corresponding community determining unit 20 may automatically determine the corresponding community to be the virtual community used by the adjacent user group.

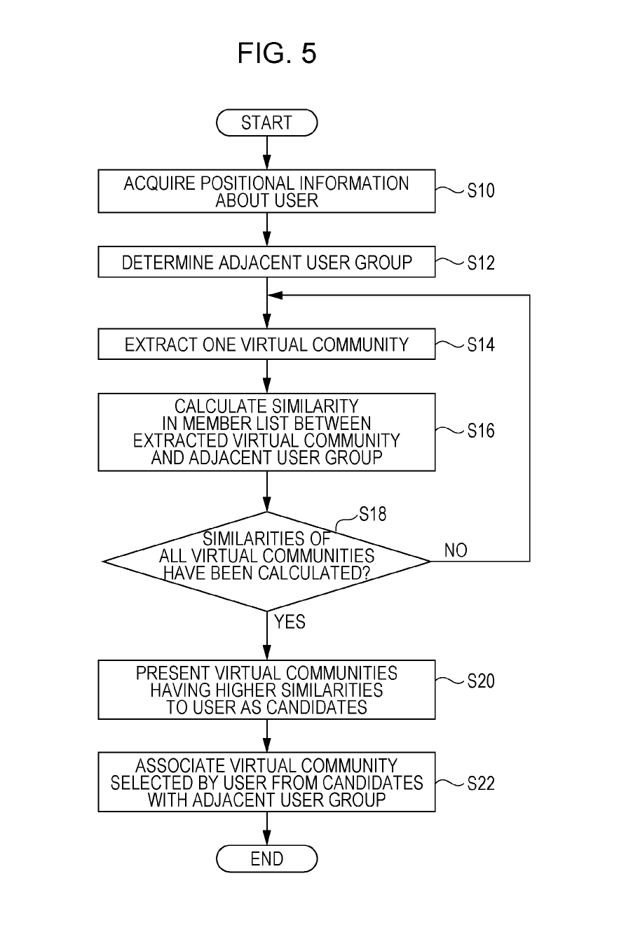

FIG. 5 is a flowchart illustrating an exemplary process executed by the system illustrated in FIG. 1. Referring to FIG. 5, in Step S10, the adjacent user group information acquiring unit 30 acquires the positional information from the mobile terminals of the respective users who holds a gathering at a physical site. In Step S12, the adjacent user group information acquiring unit 30 determines the adjacent user group (a collection of users who are adjacent to each other) from the positional information.

In Step S14, the member similarity determiner 22 extracts one virtual community from the virtual community management unit 10. In Step S16, the member similarity determiner 22 calculates the similarity between the extracted virtual community and the adjacent user group determined in Step S12. The correspondence between the calculated similarity and the virtual community is stored. If the similarity is lower than a predetermined threshold value, the virtual community may be discarded because the virtual community is not closely related to the adjacent user group (the correspondence may not be stored).

Steps S14 and S16 are repeated for all the virtual communities in the virtual community management unit 10. In Step S18, it is determined whether the calculation of the similarities of all the virtual communities to the adjacent user group is completed. If the calculation of the similarities of all the virtual communities to the adjacent user group is completed (YES in Step S18), in Step S20, the corresponding community determining unit 20 selects the virtual communities having higher similarities as the candidates and presents the list of the selected candidates to one or more users in the adjacent user group as choices. The candidates to be selected may be the virtual communities of a predetermined number from the virtual community having the highest similarity. All the virtual communities having the similarities higher than the threshold value may be selected as the candidates.

Upon selection of one virtual community from the choices as the virtual community corresponding to the current gathering by the user to which the choices are presented on the own mobile terminal, in Step S22, the corresponding community determining unit 20 in the system associates the selected virtual community with the adjacent user group. For example, the corresponding community determining unit 20 may store information posted by each user included in the adjacent user group as the content of the virtual community. The corresponding community determining unit 20 may provide a screen (for example, a Web page) of the virtual community in response to access from each user included in the adjacent user group to allow the user to acquire the content registered in the virtual community.

When a new user participates in a gathering that has been started and that is associated with any virtual community, the adjacent user group information acquiring unit 30 acquires the positional information about the user from the mobile terminal of the user upon access from the user with the own mobile terminal to the system. The fact that the user is located near the adjacent user group corresponding to the gathering is determined from the positional information, and the user is associated with the virtual community corresponding to the gathering. As a result, the user is capable of acquiring the information about the virtual community via the mobile terminal and the information transmitted from the mobile terminal of the user to the system is stored in association with the virtual community.

Since the virtual communities similar to the adjacent user group in the member list are narrowed down as the candidates in the present exemplary embodiment, it is sufficient for the user to select the virtual community corresponding to the gathering from the candidates that are narrowed down.

A modification of the above exemplary embodiment will now be described with reference to FIGS. 6 to 8. The virtual community (or the candidates for the virtual community) corresponding to the adjacent user group is determined on the basis of the similarity in the member list between the adjacent user group and the virtual community in the above exemplary embodiment. In contrast, in this modification, the virtual community corresponding to the adjacent user group is determined in consideration of other information, in addition to the similarity in the member list.

FIG. 6 is a block diagram illustrating a functional configuration of an information sharing support system according to this modification. The same reference numerals are used in FIG. 6 to identify the same elements illustrated in FIG. 1. A duplicated description of such elements is omitted herein.

The system in FIG. 6 includes a meeting information management unit 18. The meeting information management unit 18 stores and manages management information about gatherings, such as meetings, (hereinafter referred to as the “meetings”) which have been held by the user group belonging to each virtual community.

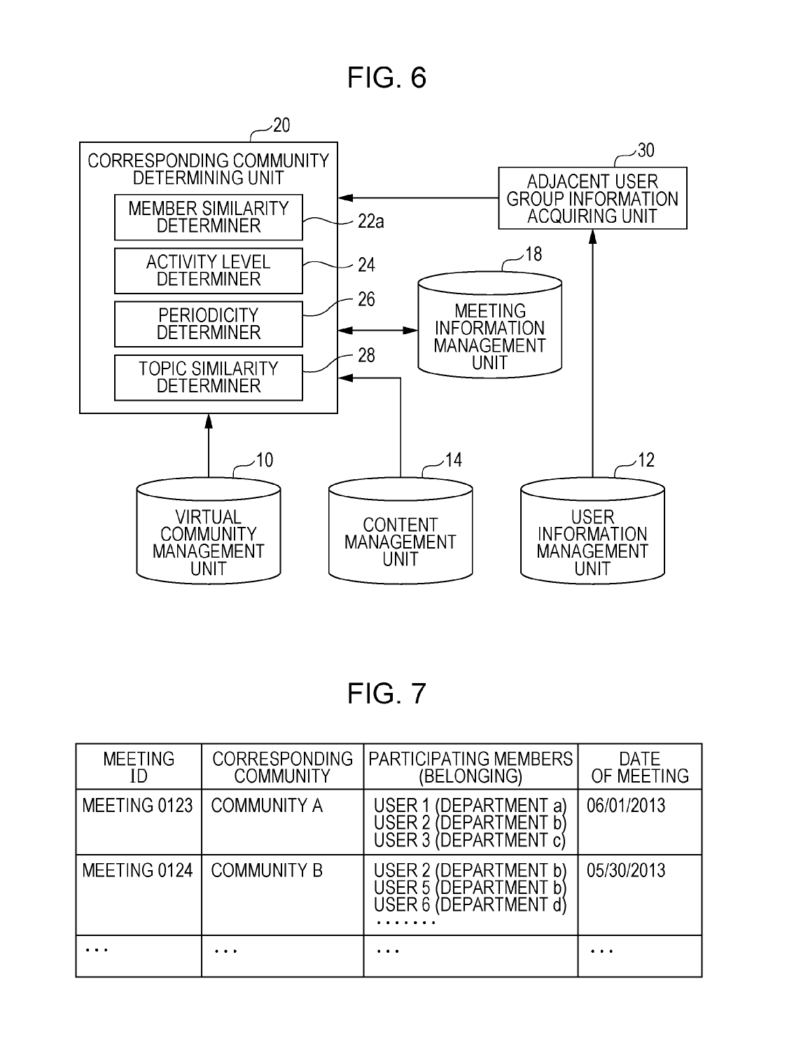

FIG. 7 illustrates an example of the management information held by the meeting information management unit 18. In the example in FIG. 7, information items including a meeting ID, a corresponding community, participating members, and a date of meeting are recorded for every meeting as the management information. The meeting ID is identification information that uniquely identifies the meeting. Different meeting IDs are given to the meetings held by the same members if the meetings are held in different dates (or different dates and times). The corresponding community indicates the community ID of the virtual community determined to correspond to the meeting (determination by the user using the support of the system or automatic determination by the system). The date of meeting is the date when the meeting is held. Information indicating the time of meeting (the start time or the end time, or both the start time and the end time) may also be recorded.

The participating members indicate the user IDs of the members who participate in the meeting. Information about the department to which each member belongs is also included in the participating-members field in the example in FIG. 7. The information about the department to which each member belongs indicates the department to which the member belongs, among the departments in an organization, such as a company. The information about the department to which each member belongs is acquired by the system from an organization information database managed by the organization (in which information including the name of each company member and the department to which the company member currently belongs is registered) when the meeting is held and the acquired information is recorded.

Referring back to FIG. 6, the corresponding community determining unit 20 includes a member similarity determiner 22a, an activity level determiner 24, a periodicity determiner 26, and a topic similarity determiner 28. The member similarity determiner 22a, the activity level determiner 24, the periodicity determiner 26, and the topic similarity determiner 28 calculate scores used to calculate the level of relevance of a certain virtual community to the adjacent user group from different points of view. The corresponding community determining unit 20 integrates the scores calculated by the respective determiners to calculate the relevance of the virtual community to the adjacent user group. At least two scores, among the scores calculated by the respective determiner, may be used in the calculation of the relevance. The virtual communities having higher relevances are selected as the candidates for the virtual community corresponding to the adjacent user group and are presented to the user as choices. For example, the virtual communities having relevances higher than a predetermined threshold value may be presented to the user in descending order of the relevances. Alternatively, the virtual community having the highest relevance may be automatically determined to be the virtual community corresponding to the adjacent user group.

The virtual community corresponding to the adjacent user group is determined on the basis of only the similarity in the member list in the above exemplary embodiment while the determination is performed in consideration of evaluated values (scores) in additional points of view in this modification. Examples of how the evaluated values are calculated in the respective points of view will now be described.

The member similarity determiner 22a takes consideration of information about the department to which each user belongs in the calculation of the similarity in the member list between the adjacent user group acquired by the adjacent user group information acquiring unit 30 and each virtual community. For example, users who are representative of departments in a company (users selected from the respective departments) are gathered in many meetings in the company. For example, when a user 1 who is representative of a department a has participated in the meetings corresponding to a virtual community A, the user 1 does not participate any meeting corresponding to the virtual community A as a representative of the department a after the user 1 moves to a department b by internal reorganization. Conversely, the probability of the correspondence of the meeting in which the user 1 participates after the internal reorganization to the virtual community A is low.

Accordingly, the member similarity determiner 22a takes consideration of the information about the departments to which the users in the adjacent user group and the members of the virtual community belong in the calculation of the similarity in the member list between the adjacent user group and each virtual community.

The information about the department to which each user in the adjacent user group belongs may be acquired from the organization information database in which the information about the department to which each user currently belongs is managed. In contrast, the information about the department to which each member of the virtual community belongs may be acquired from the information (refer to FIG. 7) about the members who participated in the past meetings corresponding to the virtual community, which is stored in the meeting information management unit 18. For example, a value of the department to which each member belongs, included in the information about the members participating in a latest meeting (a meeting that is most recently held) corresponding to the virtual community, is acquired. Alternatively, the value of the department to which each member belongs may be acquired from information about the most recent meetings of a predetermined number or the meetings that have been held during a predetermined most recent time period. If the same member belongs to different departments in the multiple most recent meetings acquired in the above manner, the department to which the member belongs in the latest meeting may be adopted by priority.

In an example, the member similarity determiner 22a uses the information about the belonging departments acquired in the above manner to count the user having the same pair of the user ID and the belonging department in both the adjacent user group and the virtual community as a user common to the adjacent user group and the virtual community. Conversely, even when the user having the same user ID is included in the adjacent user group and the virtual community, the user is not counted as the user common to the adjacent user group and the virtual community if the department to which the user belongs in the adjacent user group is different from the department to which the user belongs in the virtual community. Under this condition, the similarity between the adjacent user group and the virtual community is calculated from the number of users “common to” the adjacent user group and the virtual community or the correspondence rate between the adjacent user group and the virtual community.

In another example, a point is given to the correspondence of the user ID in the adjacent user group and the virtual community and an additional point is given when the department to which the user belongs in the adjacent user group corresponds with the department to which the user belongs in the virtual community to calculate the similarity on the basis of the sum of the points. For example, when a user 1 is included in both the adjacent user group and the virtual community and the department to which the user 1 belongs in the adjacent user group corresponds with the department to which the user 1 belongs in the virtual community, for example, two points: one point for the correspondence of the user ID and additional one point for the correspondence of the belonging department are allocated to the user 1 in the calculation of the similarity. For example, when a user 2 is included in both the adjacent user group and the virtual community and the department to which the user 2 belongs in the adjacent user group is different from the department to which the user 2 belongs in the virtual community, one point is allocated to the user 2. Zero point is allocated to a user who is included either of the adjacent user group and the virtual community or a user who is not included in both the adjacent user group and the virtual community. The sum of the points allocated to the user common to the adjacent user group and the virtual community or a value resulting from substitution of the sum into a certain calculation expression is used as the similarity in the member list between the adjacent user group and the virtual community.

The activity level determiner 24 determines the activity level of each virtual community. The activity level is a value representing the intensity of the activity of the virtual community. In an example, the virtual community has higher activity level as the date and time when a meeting at a physical site corresponding to the virtual community is held is closer to the current time. In other words, the virtual community has higher activity level as the date and time when the latest meeting is held is new with respect to the current time. The virtual community having higher activity level is made more likely to be selected as the candidate corresponding to the adjacent user group.

The periodicity determiner 26 determines whether the current meeting (the gathering of the users at the time when the adjacent user group is detected) is matched with the period on which the past meetings corresponding to the virtual community were held. If the meeting is matched with the period, the virtual community is made more likely to be selected as the candidate corresponding to the meeting. For example, a predetermined score (a plus evaluated value in terms of the periodicity) is added to the virtual community if the meeting is matched with the period and the score is not added to the virtual community if the meeting is not matched with the period.

The period on which the past meetings corresponding to the virtual community were held may be acquired from the dates when the respective meetings corresponding to the virtual community were held, which are recorded in the meeting information management unit 18.

The topic similarity determiner 28 calculates the similarity between the topic of the current meeting and the topic of the virtual community. The topic of the current meeting may be acquired by application of a topic extraction technique in the related art to a variety of information (for example, data uploaded by the participants of the meeting during the meeting or the minutes of the meeting) input into the system in association with the current meeting. The topic of the virtual community may be acquired from the topic information (refer to FIG. 4) about the content corresponding to the virtual community, which is stored in the content management unit 14. When multiple pieces of content correspond to the virtual community, the result of integration of all the topics of the multiple pieces of content may be used as the topic of the virtual community or the topics having higher frequencies, among the topics of the multiple pieces of content, may be selected (for example, by comparison with a threshold value or selection of the topics of a certain number from the topic having the highest frequency) to determine the selected topics to be the topics of the virtual community.

The similarity between the topic of the current meeting and the topic of the virtual community may be calculated on the basis of, for example, the number of topics common to the current meeting and the virtual community. For example, the similarity in the topic between the current meeting and the virtual community is increased with the increasing number of topics common to the current meeting and the virtual community.

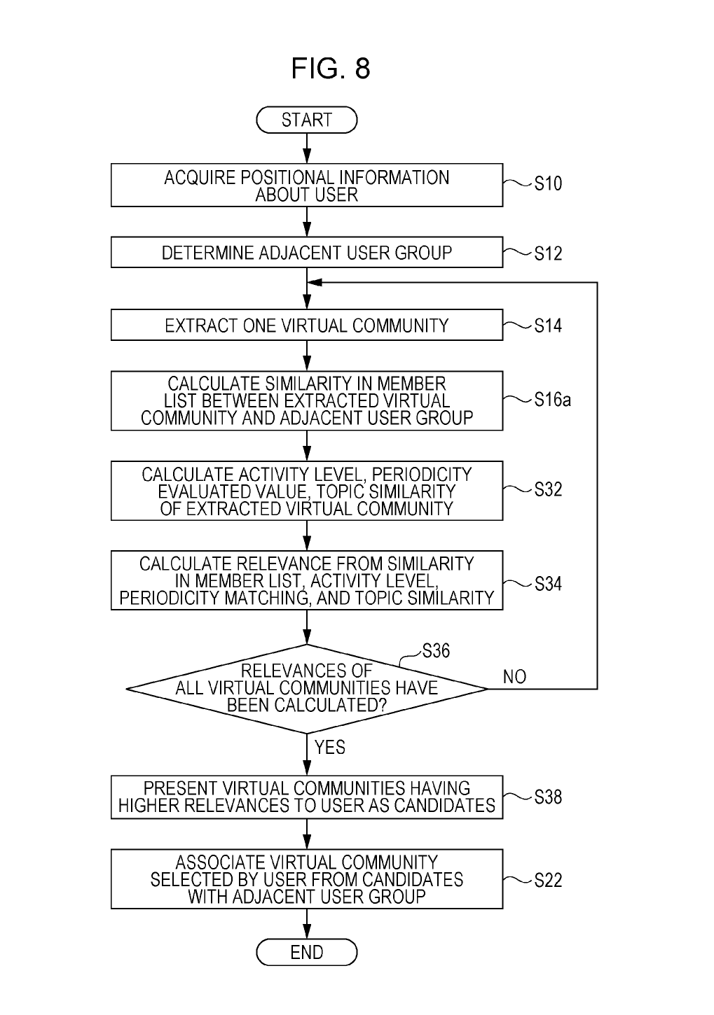

FIG. 8 is a flowchart illustrating an exemplary process according to this modification. The same numerals are used in FIG. 8 to identify the same steps illustrated in FIG. 5. A duplicated description of such steps is omitted herein.

Referring to FIG. 8, each time one virtual community is extracted from the virtual community management unit 10 in Step S14, in Step S16a, the member similarity determiner 22a calculates the similarity in the member list between the virtual community and the adjacent user group. In Step S32, the activity level determiner 24 calculates the activity level of the virtual community, the periodicity determiner 26 calculates the periodicity evaluated value of the virtual community, and the topic similarity determiner 28 calculates the topic similarity of the virtual community. The similarity is calculated in consideration of the department to which each user belongs in Step S16a. In Step S34, the evaluated values in the respective points of view, which are calculated, are integrated to calculate the relevance of the virtual community to the adjacent user group. The relevance may be calculated by the simple addition or the weighted addition of the evaluated values in the respective points of view (a calculation expression other than the simple addition or the weighted addition may be used).

Steps S14, S16a, S32, and S34 are repeated for all the virtual communities in the virtual community management unit 10. In Step S36, it is determined whether the calculation of the relevances of all the virtual communities to the adjacent user group is completed. If the calculation of the relevances of all the virtual communities to the adjacent user group is completed (YES in Step S36), in Step S38, the corresponding community determining unit 20 selects the virtual communities having higher relevances as the candidates and presents the list of the selected candidates to one or more users in the adjacent user group as choices. Upon selection of one virtual community from the choices as the virtual community corresponding to the current gathering by the user on the own mobile terminal, in Step S22, the corresponding community determining unit 20 in the system associates the selected virtual community with the adjacent user group.

Although the evaluated values in the three points of view: the activity level, the periodicity evaluated value, and the topic similarity of the virtual community are combined with the similarity in the member list to calculate the relevance in the modification described above, this method is only an example. Only one of the activity level, the periodicity evaluated value, and the topic similarity of the virtual community may be combined with the similarity in the member list or two of the activity level, the periodicity evaluated value, and the topic similarity of the virtual community may be combined with the similarity in the member list for the calculation of the relevance.

The virtual community corresponding to the adjacent user group is determined at the time when the adjacent user group participating a meeting (gathering) at a physical site is identified in the above examples. Instead of the above determination, the system may create a temporary virtual community for the identified adjacent user group and the temporary virtual community may be later merged with the existing virtual communities registered in the virtual community management unit 10. In this case, the system notifies each user included in the adjacent user group of the temporary virtual community. The user registers information in the temporary virtual community and/or browses the information registered in the temporary virtual community during the meeting to perform the information sharing.

In this example, the methods described in the above exemplary embodiment and modification are used in the determination of the candidates for the virtual community with which the temporary virtual community is merged and the automatic determination of the virtual community with which the temporary virtual community is merged.

In this example, it is not necessary to identify the virtual community in which information including documents created during the meeting is registered at the start of the meeting. The information created during the meeting is registered in the temporary virtual community specially prepared for the meeting (the adjacent user group). The system may determine the candidates for the virtual community with which the temporary virtual community is merged by the methods described in the above exemplary embodiment and modification during the meeting or after the meeting is finished to cause any user in the adjacent user group to select the virtual community with which the temporary virtual community is merged from the candidates. Alternatively, the virtual community with which the temporary virtual community is merged may be automatically determined by the methods described in the above exemplary embodiment and modification.

For example, at a time when the minutes are registered in the temporary virtual community after the meeting is finished, the virtual community having higher relevance to the meeting may be identified from the existing virtual communities in the virtual community management unit 10 by using, for example, the topic extracted from the adjacent user group which has participated in the meeting or the minutes of the meeting. For example, when the minutes are registered in the temporary virtual community by a user included in the adjacent user group, the system may determine the topic in the minutes to calculate the relevance of each virtual community from, for example, the topic or the member list of the adjacent user group by the above methods. The list of the virtual communities having higher relevances may be presented to the user to cause the user to select the virtual community corresponding to the meeting from the list. The relevance of each of the existing virtual communities to the meeting may be calculated also in consideration of the topic in other information registered in the temporary virtual community during the meeting, in addition to the minutes.

At the start of the meeting, the information, such as the minutes, to be generated during the meeting is not capable of being used in the calculation of the relevance of the virtual community.

In contrast, in this example, the use of the information, such as the minutes, generated in consideration of the meeting allows the relevance taking consideration of the topic to be calculated. The use of the relevance in consideration of the topic allows the probability of selection of a more appropriate virtual community to be increased.

In this example, if no notable achievement is produced in the meeting, the information registered in the temporary virtual community may not be registered in the virtual community management unit 10. Specifically, the system may provide a choice to merge the temporary virtual community with the proper virtual communities or clear the temporary virtual community to any of the users included in the adjacent user group. If the clearance is selected, the system deletes the data about the temporary virtual community (the management information about, for example, the participating members and the content information registered during the meeting in association with the temporary virtual community). If the merge is selected, the system identifies the proper virtual communities, which are the candidates, by the methods described in the above exemplary embodiment and modification to cause the user to select the virtual community with which the temporary virtual community is merged from the virtual communities.

The information sharing support systems described above are realized by, for example, a general-purpose computer that executes programs representing the processing in the functional modules in the apparatuses. The computer has, for example, hardware circuitry in which a microprocessor, such as a central processing unit (CPU); memories (primary storage devices) including a random access memory (RAM) and a read only memory (ROM); an hard disk drive (HDD) controller that controls an HDD; various input-output (I/O) interfaces; a network interface that controls connection to a network, such as a local area network (LAN); and so on are connected to each other via a bus. A disk drive for reading from and/or writing into a portable disk recording medium, such as a compact disc (CD) or a digital versatile disk (DVD), a memory reader-writer for reading from and/or writing into any of portable non-volatile recording media including a flash memory conforming to various standards, etc. may be connected to the bus via, for example, the I/O interfaces. The programs in which the content of processing in the functional modules described above is described are stored in a permanent storage device, such as the HDD, via the recording medium, such as the CD or the DVD, or via a communication unit, such as the Internet, to be installed in the computer. The programs stored in the permanent storage device are read out into the RAM and are executed by the microprocessor, such as the CPU, to realize the functional modules.

The elements composing each of the information sharing support systems described above may be dispersedly installed in multiple computers and communicate with each other to realize the processing in the above exemplary embodiment and modification.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A non-transitory computer readable medium storing a program causing a computer to execute a process comprising:
managing information about a user group which performs information sharing with a virtual information sharing tool for every information sharing tool;
acquiring information about a group of users who are adjacent to each other;
determining the information sharing tool corresponding to the group of users who are adjacent to each other on the basis of a relevance of each information sharing tool to the group of users who are adjacent to each other, which is calculated in accordance with a similarity between the user group corresponding to the information sharing tool, which is managed, and the group of users who are adjacent to each other indicated by the acquired information; and
presenting the information sharing tool determined to have high relevance, among the information sharing tools, as a candidate corresponding to the group of users who are adjacent to each other.

2. The non-transitory computer readable medium according to claim 1, the process further comprising:
storing an organization to which each user included in the user group corresponding to the information sharing tool belongs at a time when the user used the information sharing tool,
wherein, if the organization to which each user included in the group of users who are adjacent to each other belongs at the time of the determination is varied from the stored organization to which each user in the user group belongs in the calculation of the relevance of the information sharing tool to the group of users who are adjacent to each other, the determining reduces a level of contribution to the relevance of the user.

3. The non-transitory computer readable medium according to claim 1,
wherein the information sharing tool registers gathering record information, the process further comprising:
storing a date when a gathering corresponding to the gathering record information is held,
wherein the determining increases the relevance of the information sharing tool as the date when the gathering corresponding to the information sharing tool is held, which is stored, is closer to the time of the determination.

4. The non-transitory computer readable medium according to claim 2,
wherein the information sharing tool registers gathering record information, the process further comprising:
storing a date when a gathering corresponding to the gathering record information is held,
wherein the determining increases the relevance of the information sharing tool as the date when the gathering corresponding to the information sharing tool is held, which is stored, is closer to the time of the determination.

5. The non-transitory computer readable medium according to claim 1,
wherein the information sharing tool registers gathering record information, the process further comprising:
storing a date when a gathering corresponding to the gathering record information is held,
wherein, if a time when the group of users who are adjacent to each other has been detected is matched with a periodicity of the dates when the past gatherings corresponding to the information sharing tool were held, which are stored, the determining makes the relevance of the information sharing tool higher than that when the time is not matched with the periodicity of the dates when the past gatherings corresponding to the information sharing tool were held.

6. The non-transitory computer readable medium according to claim 1, the process further comprising:
storing a topic of each piece of information stored in the information sharing tool; and
extracting a topic from information that is acquired and that is input in association with the group of users who are adjacent to each other,
wherein the determining increases the relevance of the information sharing tool with the increasing similarity between the extracted topic and the stored topic corresponding to the information sharing tool.

7. The non-transitory computer readable medium according to claim 1,
wherein a temporary information sharing tool is provided for the information sharing by the group of users who are adjacent to each other, the process further comprising:
merging the temporary information sharing tool with the information sharing tool to be used by the group of users who are adjacent to each other, which is identified on the basis of the result of the determination.

8. An information sharing support system comprising:
an information sharing management unit that manages information about a user group which performs information sharing with a virtual information sharing tool for every information sharing tool;
an adjacent user group information acquiring unit that acquires information about a group of users who are adjacent to each other;
a determining unit that determines the information sharing tool corresponding to the group of users who are adjacent to each other on the basis of a relevance of each information sharing tool to the group of users who are adjacent to each other, which is calculated in accordance with a similarity between the user group corresponding to the information sharing tool, which is managed by the information sharing management unit, and the group of users who are adjacent to each other indicated by the information acquired by the adjacent user group information acquiring unit; and
a presenting unit that presents the information sharing tool determined to have high relevance by the determining unit, among the information sharing tools, as a candidate corresponding to the group of users who are adjacent to each other.

9. A non-transitory computer readable medium storing a program causing a computer to execute a process comprising:
managing member information about a user group which performs information sharing with a virtual information sharing tool for every information sharing tool and information indicating an activity status including a date when an activity is held;
acquiring information about a group of users who are adjacent to each other;
determining the information sharing tool corresponding to the group of users who are adjacent to each other on the basis of a relevance calculated between the information about the group of users who are adjacent to each other and each information sharing tool; and
presenting the information sharing tool determined to have high relevance, among the information sharing tools, as a candidate corresponding to the group of users who are adjacent to each other,
wherein the determining calculates the relevance by using at least two of a similarity calculated from a correspondence between a member list of the user group and a members list of the group of users who are adjacent to each other, a date when a recent activity of each information sharing tool is held, and a periodicity of dates when past activities of each information sharing tool were held.

10. An information sharing support method comprising:
managing information about a user group which performs information sharing with a virtual information sharing tool for every information sharing tool;
acquiring information about a group of users who are adjacent to each other;
determining the information sharing tool corresponding to the group of users who are adjacent to each other on the basis of a relevance of each information sharing tool to the group of users who are adjacent to each other, which is calculated in accordance with a similarity between the user group corresponding to the information sharing tool, which is managed, and the group of users who are adjacent to each other indicated by the acquired information; and
presenting the information sharing tool determined to have high relevance, among the information sharing tools, as a candidate corresponding to the group of users who are adjacent to each other.

11. An information sharing support method comprising:
managing member information about a user group which performs information sharing with a virtual information sharing tool for every information sharing tool and information indicating an activity status including a date when an activity is held;
acquiring information about a group of users who are adjacent to each other;
determining the information sharing tool corresponding to the group of users who are adjacent to each other on the basis of a relevance calculated between the information about the group of users who are adjacent to each other and each information sharing tool; and
presenting the information sharing tool determined to have high relevance, among the information sharing tools, as a candidate corresponding to the group of users who are adjacent to each other,
wherein the determining calculates the relevance by using at least two of a similarity calculated from a correspondence between a member list of the user group and a members list of the group of users who are adjacent to each other, a date when a recent activity of each information sharing tool is held, and a periodicity of dates when past activities of each information sharing tool were held.
